(19) United States
(12) Patent Application Publication
(10) Pub. No.: US 2024/0343479 A1
(43) Pub. Date: Oct. 17, 2024

(54) Trash Receptacle Device

(71) Applicant: Patrick Serafine, Waterbury, CT (US)

(72) Inventor: Patrick Serafine, Waterbury, CT (US)

(21) Appl. No.: 18/366,409

(22) Filed: Aug. 7, 2023

Related U.S. Application Data
(60) Provisional application No. 63/496,495, filed on Apr. 17, 2023.

(51) Int. Cl. B65F 1/16

(52) U.S. Cl. CPC B65F 1/1646; B65F 1/1607

(57) ABSTRACT

A trash receptacle device is disclosed that turns five-gallon buckets into garbage cans. The trash receptacle device comprises a base component that is configured in a circular shape that would be compatible with a five-gallon bucket. The base component would be snapped onto the bucket during use. Specifically, the base component would comprise a frame portion with a central single flap portion or a central double flap portion that allows trash to be pushed through. The flaps, when pushed open, reveal the bucket interior. Once the garbage is pushed through the flaps, it will be stored in the bucket until it is removed and properly disposed of.

### CROSS-REFERENCE TO RELATED APPLICATION

The present application claims priority to, and the benefit of, U.S. Provisional Application No. 63/496,495, which was filed on Apr. 17, 2023, and is incorporated herein by reference in its entirety.

### FIELD OF THE INVENTION

The present invention relates generally to the field of trash receptacle devices. More specifically, the present invention relates to a modified trash receptacle lid that can turn five-gallon buckets into a simple and accessible trash receptacle. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in trash receptacle devices. Generally, when working on different job sites, five-gallon buckets are commonly present for storage and other uses. Further, people may lack access to a proper trash can while working. Additionally, standard trash receptacles may be heavy, bulky, and difficult to transport. However, throwing trash on the ground can clutter a workspace and create unsanitary environments.

Accordingly, there is a demand for an improved trash receptacle device that provides a universal garbage can lid that is designed to turn five-gallon buckets into a garbage can. More particularly, there is a demand for a trash receptacle device that can easily snap onto five-gallon buckets and provide a central flap portion for pushing garbage through.

Therefore, there exists a long-felt need in the art for a trash receptacle device that provides users with a modified trash receptacle lid that can turn five-gallon buckets into a simple and accessible trash receptacle. There is also a long-felt need in the art for a trash receptacle device that features a double flap that opens in the center to receive trash. Further, there is a long-felt need in the art for a trash receptacle device that features a single flap that can be pushed open to throw away items. Moreover, there is a long-felt need in the art for a device that allows users to snap the lid onto the bucket perimeter to quickly transform the bucket into a trash receptacle. Further, there is a long-felt need in the art for a trash receptacle device that reduces litter and prevents people from throwing trash on the ground and creating unsanitary environments. Finally, there is a long-felt need in the art for a trash receptacle device that can be manufactured of plastic or rubber.

The subject matter disclosed and claimed herein, in one embodiment thereof, comprises a trash receptacle device. The device is a universal garbage can lid that is designed to turn five-gallon buckets into a garbage can. The trash receptacle device comprises a base component that is configured in a circular shape that would be compatible with every five-gallon bucket available. The base component would be snapped onto the bucket during use. Specifically, the base component would comprise a frame portion with a central single flap portion or a central double flap portion that allows trash to be pushed through. The flaps, when pushed open, reveal the bucket interior. Once the garbage is pushed through the flaps, it will be stored in the bucket until it is removed and properly disposed of. The device can be constructed using plastic, rubber, or other suitable materials.

In this manner, the trash receptacle device of the present invention accomplishes all of the foregoing objectives and provides users with a device that turns buckets into accessible trash receptacles. The device is a universal lid that is configured to attach to a standard five-gallon bucket. The device can be manufactured of a plastic or rubber material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trash receptacle device. The device is a universal garbage can lid that is designed to turn five-gallon buckets into a garbage can. The trash receptacle device comprises a base component that is configured in a circular shape that would be compatible with every five-gallon bucket available. The base component would be snapped onto the bucket during use. Specifically, the base component would comprise a frame portion with a central single flap portion or a central double flap portion that allows trash to be pushed through. The flaps, when pushed open, reveal the bucket interior. Once the garbage is pushed through the flaps, it will be stored in the bucket until it is removed and properly disposed of.

In one embodiment, the present invention provides a lid for a bucket or other circular waste receptacle which conceals from exterior view, the sight of the bucket interior or an interior liner. The bucket can be any suitable bucket as is known in the art but is typically circular in configuration and generally five gallons in volume. However, the device can be manufactured in multiple sizes to engage multiple sizes of buckets.

In one embodiment, the trash receptacle device comprises a base component. The base component can be any suitable shape and size as is known in the art. Further, the base component is typically circular in shape to engage the circular bucket but can be any suitable shape as is known in the art, depending on the shape of the bucket it is engaging.

In one embodiment, the base component can be manufactured of various materials including, but not limited to, rubber, plastics, or other commonly used materials. The base component can be formed in various shapes including, but not limited to, square, rectangular, semi-round, round, oval, or any other practical shapes known to those of ordinary skill in the art.

In one embodiment, the base component is secured to an upper perimeter of the bucket via a snap fit, threads, adhesive, etc., or any other suitable securing means as is known in the art. In one embodiment, the base component comprises an extended collar which fits concentrically around an upper portion of the perimeter of the bucket when the base component is covered over the opening of the bucket. The collar extends the length and the depth of the base component to conceal at least a portion of the exterior surface of the body of the bucket, thereby concealing at least a portion of any removable interior liner situated within and exceeding and/or overlapping an upper rim of the bucket.

In one embodiment, the base component comprises a frame portion with an opening and a central flap portion that acts to cover the opening. The frame portion can be a raised spherical structure that secures over a bucket opening to fully enclose the bucket. However, the frame portion can be flat or slightly domed or raised, depending on the wants and/or needs of a user. The opening of the frame portion can be any suitable shape and size as is known in the art, depending on the needs and/or wants of a user.

In another embodiment, the central flap portion comprises one or two flap portions depending on the needs and/or wants of a user. Each flap portion is typically shaped as a semi-circle, however the flap portion can be any suitable shape and size as is known in the art, as long as they are sized and shaped to cover the opening of the frame portion. In the embodiment where there are two flap portions, the semi-circles are positioned in an abutting configuration. The flap portions are secured via hinges to the opening, allowing the flap portions to be opened and closed, as needed. Specifically, the flap portions can be configured in an open configuration and a closed configuration. The open configuration provides access to the interior of the bucket and allows a user to push trash through the opening of the frame portion. The closed configuration restricts access to the interior of the bucket and prevents a user from viewing inside the bucket. Typically, the hinges are spring-loaded hinges which allow the flap portions to automatically spring back into their closed position once a user pushes them open.

In one embodiment, the bucket used with the trash receptacle device comprises a handle. The handle is secured to the bucket via any suitable securing means and allows a user to move the trash receptacle device around easier.

In yet another embodiment, the trash receptacle device comprises a plurality of indicia.

In yet another embodiment, a method of converting a five-gallon bucket into a trash receptacle is disclosed. The method includes the steps of providing a trash receptacle device comprising a circular base component with a frame portion and a central flap portion. The method also comprises snapping the base component onto a five-gallon bucket. Further, the method comprises pushing trash through the central flap portion. Finally, the method comprises storing the trash within the five-gallon bucket until it is removed and properly disposed of.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a front perspective view of one embodiment of the trash receptacle device of the present invention in accordance with the disclosed architecture;

FIGS. 2A-B illustrate a top perspective view of one embodiment of the trash receptacle device of the present invention showing the double flap configuration of the device in accordance with the disclosed architecture;

FIG. 3 illustrates a perspective view of one embodiment of the trash receptacle device of the present invention showing the device applied to a bucket in accordance with the disclosed architecture;

FIG. 4 illustrates a front perspective view of one embodiment of the trash receptacle device of the present invention showing a single flap configuration of the device in accordance with the disclosed architecture;

FIGS. 5A-B illustrate a top perspective view of one embodiment of the trash receptacle device of the present invention in use in accordance with the disclosed architecture; and

FIG. 6 illustrates a flowchart showing the method of converting a five-gallon bucket into a trash receptacle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a trash receptacle device that provides users with a modified trash receptacle lid that can turn five-gallon buckets into a simple and accessible trash receptacle. There is also a long-felt need in the art for a trash receptacle device that features a double flap that opens in the center to receive trash. Further, there is a long-felt need in the art for a trash receptacle device that features a single flap that can be pushed open to throw away items. Moreover, there is a long-felt need in the art for a device that allows users to snap the lid onto the bucket perimeter to quickly transform the bucket into a trash receptacle. Further, there is a long-felt need in the art for a trash receptacle device that reduces litter and prevents people from throwing trash on the ground and creating unsanitary environments. Finally, there is a long-felt need in the art for a trash receptacle device that can be manufactured of plastic or rubber.

The present invention, in one exemplary embodiment, is a novel trash receptacle device. The trash receptacle device comprises a base component that is configured in a circular shape that would be compatible with every five-gallon bucket available. The base component would be snapped onto the bucket during use. Specifically, the base component would comprise a frame portion with a central single flap portion or a central double flap portion that allows trash to be pushed through. Once the garbage is pushed through the flaps, it will be stored in the bucket until it is removed and properly disposed of. The present invention also includes a novel method of converting a five-gallon bucket into a trash receptacle. The method includes the steps of providing a trash receptacle device comprising a circular base component with a frame portion and a central flap portion. The method also comprises snapping the base component onto a five-gallon bucket. Further, the method comprises pushing trash through the central flap portion. Finally, the method comprises storing the trash within the five-gallon bucket until it is removed and properly disposed of.

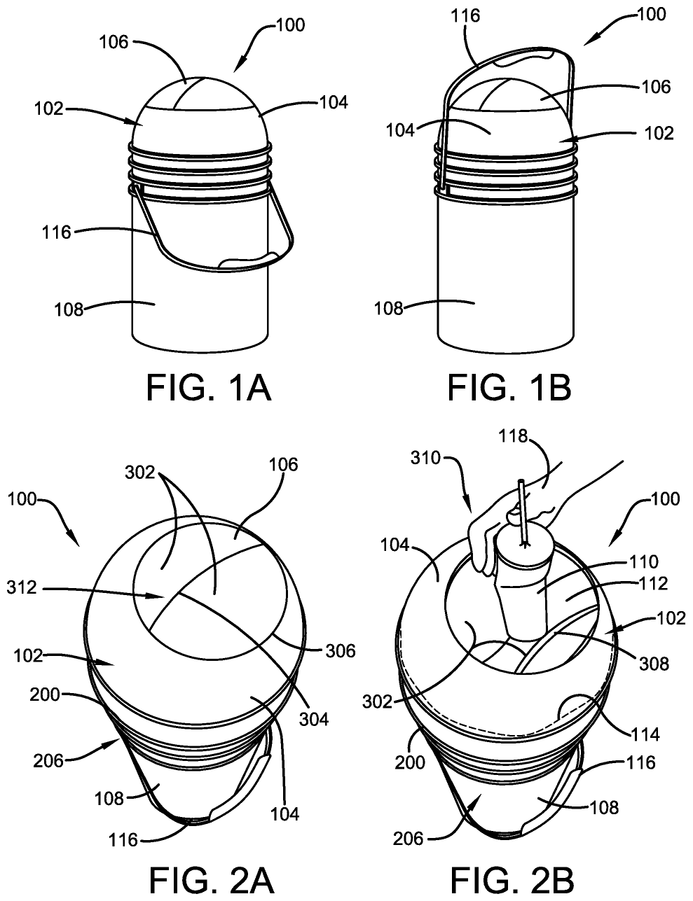

Referring initially to the drawings, FIGS. 1A-B illustrate a perspective view of one embodiment of the trash receptacle device 100 of the present invention. In the present embodiment, the trash receptacle device 100 is an improved trashed receptacle device 100 that provides a user with a universal lid that is configured to turn five-gallon buckets into a garbage can. Specifically, the trash receptacle device 100 comprises a base component 102 with a frame portion 104 and a central flap portion 106. The base component 102 would be snapped onto the bucket 108 during use. Specifically, the central flap portion 106 allows trash 110 to be pushed through. The flaps 106, when pushed open, reveal the bucket interior 112. Once the garbage 110 is pushed through the flaps 106, it will be stored in the bucket 108 until it is removed and properly disposed of.

Generally, the present invention provides a lid for a bucket 108 or other circular waste receptacle which conceals from exterior view, sight of the bucket interior 112 or an interior liner 114. The bucket 108 can be any suitable bucket 108 as is known in the art but is typically circular in configuration and generally five gallons in volume. However, the device 100 can be manufactured in multiple sizes and shapes to engage multiple sizes of buckets 100.

Furthermore, the trash receptacle device 100 comprises a base component 102. The base component 102 can be any suitable shape and size as is known in the art. Further, the base component 102 is typically circular in shape to engage a circular bucket 108 but can be any suitable shape as is known in the art, depending on the shape of the bucket 108 it is engaging. For example, the base component 102 can be square in shape, such that it can engage a square bucket or similarly shaped bucket, as is known in the art.

In one embodiment, the bucket 108 used with the trash receptacle device 100 comprises a handle 116. The handle 116 is secured to the bucket 108 via any suitable securing means and allows a user 118 to move the trash receptacle device 100 around easier.

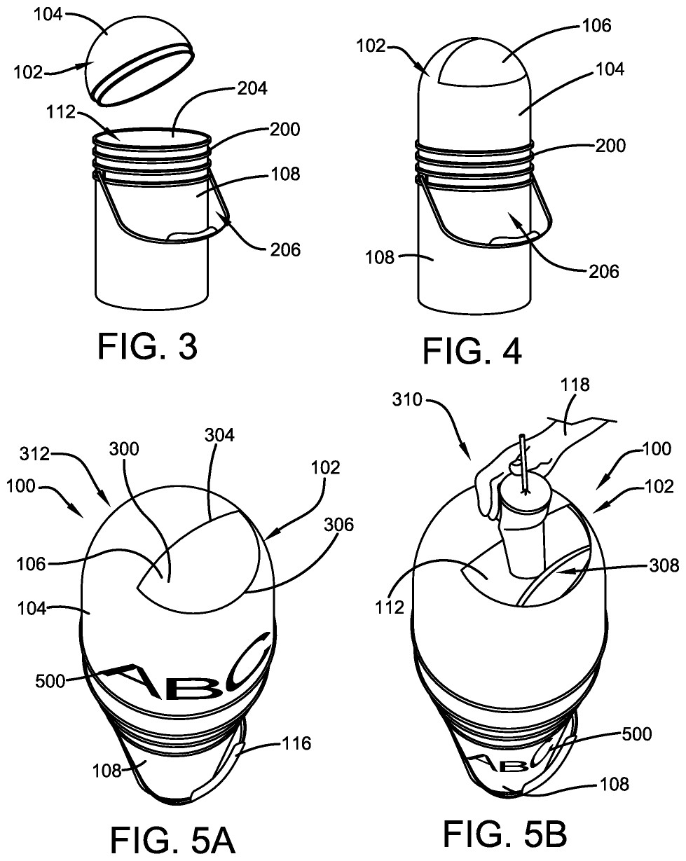

As shown in FIGS. 2A-B, FIG. 3 and FIG. 4, the base component 102 is secured to an upper perimeter 200 of the bucket 108 via a snap fit, threads, adhesive, etc., or any other suitable securing means as is known in the art. In one embodiment, the base component 102 comprises an extended collar 202 which fits concentrically around an upper portion 200 of the perimeter of the bucket 108, when the base component 102 is covered over the opening 204 of the bucket 108. The collar 202 extends the length and the depth of the base component 102 to conceal at least a portion of the exterior surface 206 of the body of the bucket 108, thereby concealing at least a portion of any removable interior liner 114 situated within and exceeding and/or overlapping an upper rim 200 of the bucket 108.

As shown in FIG. 3, the base component 102 comprises a frame portion 104 with an opening 204 and a central flap portion 106 that acts to cover the opening 204. The frame portion 104 can be a raised spherical structure that secures over a bucket 108 opening 204 to fully enclose the bucket 108. However, the frame portion 104 can be flat or slightly domed or raised, depending on the wants and/or needs of a user 118. The opening 204 of the frame portion 104 can be any suitable shape and size as is known in the art, depending on the needs and/or wants of a user 118.

As shown in FIGS. 2A-B and FIG. 5A-B, the central flap portion 106 comprises one 300 or two 302 flap portions, depending on the needs and/or wants of a user 118. Each flap portion 300 and 302 is typically shaped as a semi-circle (i.e., with a straight section 304 and a curved section 306), however the flap portions 300 and 302 can be any suitable shape and size as is known in the art, as long as they are sized and shaped to cover the opening 204 of the frame portion 104. In the embodiment where there are two flap portions 302, the semi-circles 304 and 306 are positioned in an abutting configuration. The flap portions 300 and 302 are secured via hinges 308 to the opening 204, allowing the flap portions 300 and 302 to be opened and closed, as needed. Specifically, the flap portions 300 and 302 can be configured in an open configuration 310 and a closed configuration 312. The open configuration 310 provides access to the interior 112 of the bucket 108 and allows a user 118 to push trash 110 through the opening 204 of the frame portion 104. The closed configuration 312 restricts access to the interior 112 of the bucket 108 and prevents a user 118 from viewing inside the bucket 108. Typically, the hinges 308 are spring-loaded hinges which allow the flap portions 300 and 302 to automatically spring back into their closed position 312 once a user 118 pushes them open 310.

As shown in FIG. 4, the base component 102 can be manufactured of various materials, such as a lightweight, durable material including plastic, rubber, or the like and manufactured through common extruding and molding processes. Specifically, the device 100 can be manufactured from heat-scalable plastic or polymers, such as polypropylene or acrylonitrile butadiene styrene (ABS), or any other suitable material as is known in the art, such as but not limited to, polycarbonate, polyethylene, polyethylene terephthalate, polyvinyl chloride, polystyrene, etc. Generally, the trash receptacle device 100 is also manufactured from a material that is water resistant or waterproof, or the base component 102 comprises a coating that is water resistant or waterproof. Furthermore, the device 100 can be molded in various colors and patterns to match existing decor or may be molded in transparent or translucent plastic as well, such that a user can view the interior of the base component 102, based upon a user's preference. In another embodiment, the trash receptacle device 100 is made of antibacterial or antimicrobial material or the base component 102 comprises a coating that is antibacterial or antimicrobial. Further, the base component 102 can be formed in various shapes including, but not limited to, square, rectangular, semi-round, round, oval, or any other practical shapes known to those of ordinary skill in the art.

As shown in FIGS. 5A-B, the trash receptacle device 100 comprises a plurality of indicia 500. The base component 102 of the device 100 may include advertising, trademark, other letters, designs, or characters, printed, painted, stamped, or integrated into the base component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be trash, bucket, or brand related.

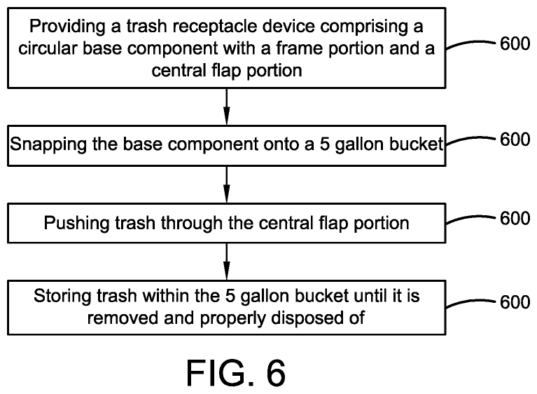

FIG. 6 illustrates a flowchart of the method of converting a five-gallon bucket into a trash receptacle. The method includes the steps of at 600, providing a trash receptacle device comprising a circular base component with a frame portion and a central flap portion. The method also comprises at 602, snapping the base component onto a five-gallon bucket. Further, the method comprises at 604, pushing trash through the central flap portion. Finally, the method comprises at 606, storing the trash within the five-gallon bucket until it is removed and properly disposed of.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “trash receptacle device”, “trash device”, “receptacle device”, and “device” are interchangeable and refer to the trash receptacle device 100 of the present invention.

Notwithstanding the foregoing, the trash receptacle device 100 of the present invention can be of any suitable size and configuration as is known in the art without affecting the overall concept of the invention, provided that it accomplishes the above-stated objectives. One of ordinary skill in the art will appreciate that the trash receptacle device 100 as shown in FIGS. 1-6 are for illustrative purposes only, and that many other sizes and shapes of the trash receptacle device 100 are well within the scope of the present disclosure. Although the dimensions of the trash receptacle device 100 are important design parameters for user convenience, the trash receptacle device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trash receptacle device that provides a user with a universal lid that is configured to turn a bucket into trash receptacle, the trash receptacle device comprising:
a base component;
a frame component; and
a central flap portion;
wherein the base component is snapped onto a bucket during use; and
further wherein trash is pushed through the central flap portion and stored in the bucket until it is removed and properly disposed of.

2. The trash receptacle device of claim 1, wherein the base component is circular in shape.

3. The trash receptacle device of claim 2, wherein the bucket used with the trash receptacle device comprises a handle.

4. The trash receptacle device of claim 3, wherein the base component is secured to an upper perimeter of the bucket via a snap fit.

5. The trash receptacle device of claim 4, wherein the base component comprises an extended collar which fits concentrically around an upper portion of the upper perimeter of the bucket, when the base component is covered over an opening of the bucket.

6. The trash receptacle device of claim 5, wherein the base component comprises the frame portion which comprises an opening and the central flap portion acts to cover the opening.

7. The trash receptacle device of claim 6, wherein the frame portion is a raised spherical structure that secures over a bucket opening to fully enclosed the bucket.

8. The trash receptacle device of claim 7, wherein the central flap portion comprises one flap shaped as a semi-circle.

9. The trash receptacle device of claim 8, wherein the central flap portion comprises two flaps shaped as a semi-circle.

10. The trash receptacle device of claim 9, wherein the two flaps are positioned in an abutting configuration.

11. The trash receptacle device of claim 10, wherein the central flap portion is secured via spring-loaded hinges to the opening of the frame portion.

12. The trash receptacle device of claim 11, wherein the central flap portion can be configured in an open configuration which provides access to an interior of the bucket and allows a user to push trash through the opening of the frame portion.

13. The trash receptacle device of claim 12, wherein the central flap portion can be configured in a closed configuration which restricts access to the interior of the bucket and prevents a user from viewing inside the bucket.

14. A trash receptacle device that provides a user with a universal lid that is configured to turn a bucket into trash receptacle, the trash receptacle device comprising:
a base component;
a frame component; and
a central flap portion;
wherein the base component is secured to an upper perimeter of a five-gallon bucket via a snap fit;
wherein the base component comprise the frame portion which comprises an opening and the central flap portion acts to cover the opening;
wherein the frame portion is a raised spherical structure that secures over a bucket opening to fully enclosed the five-gallon bucket;
wherein the central flap portion is secured via spring-loaded hinges to the opening of the frame portion;
wherein the central flap portion can be configured in an open configuration which provide access to an interior of the bucket and allows a user to push trash through the opening of the frame portion;
wherein the central flap portion can be configured in a closed configuration which restricts access to the interior of the bucket and prevents a user from viewing inside the bucket; and
further wherein trash is pushed through the central flap portion and stored in the five-gallon bucket until it is removed and properly disposed of.

15. The trash receptacle device of claim 14 further comprising a plurality of indicia.

16. The trash receptacle device of claim 14, wherein the central flap portion comprises one flap shaped as a semi-circle.

17. The trash receptacle device of claim 14, wherein the central flap portion comprises two flaps shaped as a semi-circle.

18. The trash receptacle device of claim 17, wherein the two flaps are positioned in an abutting configuration.

19. The trash receptacle device of claim 14, wherein the base component comprises an extended collar which fits concentrically around an upper portion of the upper perimeter of the bucket, when the base component is covered over an opening of the bucket.

20. A method of converting a five-gallon bucket into a trash receptacle, the method comprising the following steps:
providing a trash receptacle device comprising a circular base component with a frame portion and a central flap portion;
snapping the base component onto a five-gallon bucket;
pushing trash through the central flap portion; and
storing the trash within the five-gallon bucket until it is removed and properly disposed of.
